(19) United States
(12) Patent Application Publication
(10) Pub. No.: US 2006/0232970 A1
(43) Pub. Date: Oct. 19, 2006

(54) Hanging decorative lights

(76) Inventor: Ken Cheng, Kowloon (HK)

Correspondence Address: CHARLES C.H. WU, 98 DISCOVERY, IRVINE, CA, 92618-3105, US

(21) Appl. No.: 11/104,751

(22) Filed: Apr. 13, 2005

(51) Int. Cl. F21S 13/14

(52) U.S. Cl. 362/252

(57) ABSTRACT

A hanging lights having decorative members is provided. The hanging lights includes a rope light having a tube enclosing at least one set of micro-bulbs electrically connected in series; and a hanging cord longitudally, and substantially tracing rope light, the hanging cord having a first end affixed on a third member for hanging and substantially bears the weight of hanging lights, thereby hanging cord substantially carries the weight of rope light.

### BACKGROUND OF THE INVENTION

1. Field of the Invention

The invention pertains to the field of hanging lights. More particularly, the invention pertains to a hanging rope light with decorative features and moisture insulating features.

2. Description of Related Art

Holiday decorations such as Christmas related decorations, e.g. Santa, Snowman, sleigh, or reindeer are known. Typically, these decorations are place either outside a house or within the house as individual or independent decorations.

Rope light that typically the lights manufactured in long tubes is known. A typical rope light includes a multiplicity of micro-bulbs, spaced about one inch apart and housed in a suitable housing.

During these holidays, some household may hang decorative, or festival lights both outside or within a house. These lights sometimes have holiday decorations attached thereto. However, due the weight of the decorations, the lights may not carry too heavy, or too big sized ones.

Therefore, it is desirable a have a hanging lights that provides a member which substantially bear the weight of the decorations, as well as the weight of the rope light itself.

### SUMMARY OF THE INVENTION

A hanging light having decorative members is provided. The hanging lights includes a rope light having a tube enclosing at least one set of micro-bulbs electrically connected in series; and a hanging cord longitudally, and substantially tracing rope light, the hanging cord having a first end affixed on a third member for hanging and substantially bears the weight of hanging lights, thereby hanging cord substantially carries the weight of rope light.

### BRIEF DESCRIPTION OF THE DRAWING

FIG. 1 shows an embodiment of the present invention.

FIG. 1 shows a sectional view of FIG. 1.

FIG. 2 shows an alternate hanging member of the present invention.

### DETAILED DESCRIPTION OF THE INVENTION

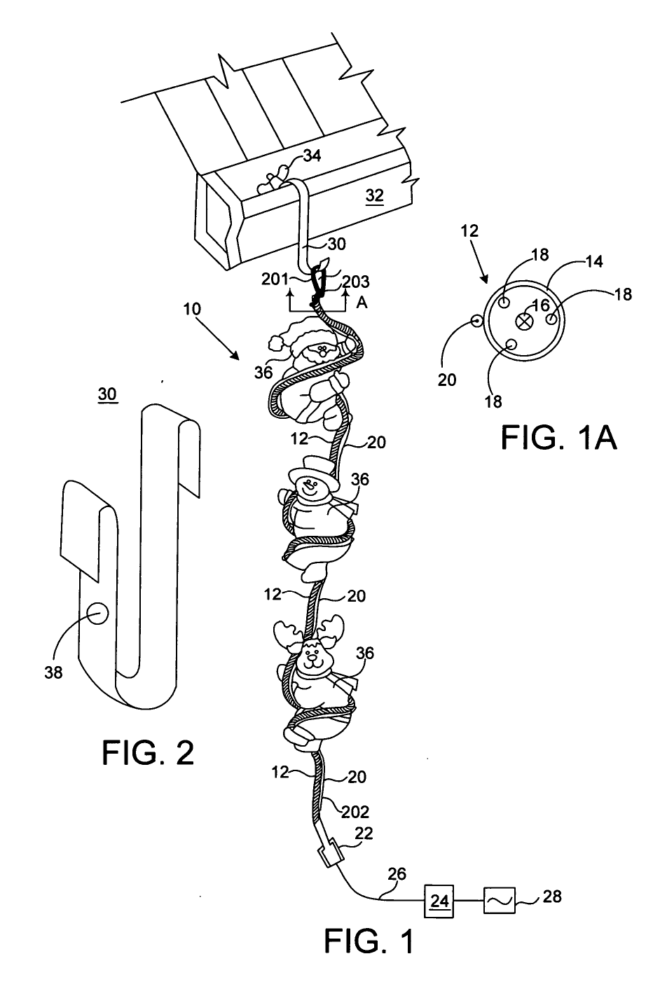

Referring to FIGS. 1 and 1A, a hanging lights 10 is depicted. A rope light 12 includes a tube 14 as its outer member. Enclosed within tube 14 is a set of micro-bulbs 16 (only one shown) having at least portions of the same connected in series. A set of steel cables 18 for given rope light 12 flexibility and strength is also enclosed within tube 14. Tube 14 may be made from clear or colored flexible polyvinylchloride (PVC) resin tube.

A hanging cord 20 longitudally, and substantially tracing rope light 12 is provided. Hanging cord 20 is rigidly affixed or tied onto rope light 12 on at least one location (not shown). Hanging cord 20 may be made of nylon cord or other suitable materials that are capable of sustaining the weight of hanging lights 10. Hanging cord 20 has a first end 201 and a second end 202, disposed at the respective ends of hanging cord 20.

Hanging cord 12 has a first end (not shown) and a second end 202. Each end functions to seal the micro-bulbs 16 within tube 14. This way, moistures or other elements outside tube 14 may not unduly influence elements such at micro-bulbs 16 or steel cable 18 within tube 14.

A power cord connector 24 electrically coupled to micro-bulbs 16 and its concomitant wiring (not shown) within tube 14 by means of power cord 26 which extends out of tube sealer 22 is provided. Power cord connector 24 is adapted to be connected to a power source 28. Power source 28 may be an alternate current (AC) outlet. In an alternative embodiment, a low-volt transformer (not shown) may be interposed between power cord connector 24 and power source 28, thereby a lower voltage is supplied to rope light 12.

At first end 202, a knot 203 is formed for connecting or hanging onto a hook such as an “S” shaped hook 30. Therefore, hanging cord 20 is conveniently hang onto “S” shaped hook 30, which in turn is hung onto a stable third member such as gutter 32 at a lower end of a residential or commercial building. A screw such as a butterfly screw 34 may be used to rigidly affix “S” shaped hook 30 onto gutter 32.

Decorative members 36 is further included in hanging lights. Only three types of decorative members is shown herein, i.e. a Santa Clause, a Snowman, and a reindeer. However, other type of decorative members may be used as desired. Decorative members may be made of wood, polymer, metal, or other suitable materials. Each decorative members has at least one aperture (not shown) for a tie (also not shown) that is designated to thread through for tying rope light 12 and hanging cord 20 onto decorative members.

As can be seen, micro-bulbs 16 and steel cable 18 are hermetically sealed within tube 14. Therefore, outside moisture, increment weather, and living organisms are less likely to affect micro-bulbs 16 and steel cable 18 within the tube light 12.

Referring to FIG. 2, a second embodiment of “S” shaped hook 30 is depicted. As can be seen, “S” shaped hook 30 has a simple structure, which is easy to manufacture and manipulate. A threaded aperture 38 may be formed. Aperture 38 is adapted to receive a threaded bolt such as the 34 of FIG. 1 for tightening “S” shaped hook 30 onto a third member.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A hanging lights comprising:
a rope light having a tube enclosing at least one set of micro-bulbs electrically connected in series; and
a hanging cord longitudally, and substantially tracing rope light, the hanging cord having a first end affixed on a third member for hanging and substantially bears the weight of hanging lights, thereby hanging cord substantially carries the weight of rope light.

2. The hanging lights of claim 1 further comprising at least one decorative member having the hanging cord connected thereto and substantially carrying the weight of the at least one decorative member.

3. The hanging lights of claim 1, wherein the hanging cord comprises a nylon cord.

4. The hanging lights of claim 1, wherein the hanging cord has a first end, which forms a ring by having a knot tied, such that the ring is adapted to hang upon a third member.
